(19) United States
(12) Patent Application Publication
(10) Pub. No.: US 2007/0115496 A1
(43) Pub. Date: May 24, 2007

(54) Recording-medium management system, disposal processing apparatus, and disposal processing method

(75) Inventors: Ryuuichi Shiraishi, Kanagawa (JP); Hiroyoshi Uejo, Kanagawa (JP); Shunsuke Hamasuna, Kanagawa (JP); Kengo Shinozaki, Kanagawa (JP); Shusaku Kubo, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/519,850

(22) Filed: Sep. 13, 2006

(30) Foreign Application Priority Data
Oct. 12, 2005 (JP) 2005-297285
Jan. 31, 2006 (JP) 2006-022699

(51) Int. Cl. G06K 15/00

(52) U.S. Cl. 358/1.14

(57) ABSTRACT

A recording-medium management system includes a recording-medium management apparatus and a disposal processing apparatus. The recording-medium management apparatus manages pieces of identification information attached to recording media. The disposal processing apparatus disposes of a recording medium when receiving disposal permission from the recording-medium management apparatus based on the identification information. The disposal processing apparatus includes a disposal processing unit, a restricting unit, a reading unit. The disposal processing unit disposes of the recording medium. The restricting unit restricts disposal by the disposal processing unit. The reading unit reads identification information from the recording medium, which is positioned by the restricting unit.

### BACKGROUND

### Technical Field

The invention relates to a recording-medium management system, a disposal processing apparatus, and a disposal processing method which are suitable for use in management of recording media.

### SUMMARY

According to an aspect of the invention, a recording-medium management system includes a recording-medium management apparatus and a disposal processing apparatus. The recording-medium management apparatus manages pieces of identification information attached to recording media. The disposal processing apparatus disposes of a recording medium when receiving disposal permission from the recording-medium management apparatus. The disposal processing apparatus includes a disposal processing unit, a restricting unit, a reading unit. The disposal processing unit disposes of the recording medium. The restricting unit restricts disposal by the disposal processing unit. The reading unit reads identification information from the recording medium, which is positioned by the restricting unit.

### BRIEF DESCRIPTION OF THE DRAWINGS

Exemplary embodiments of invention will be described in detail based on the following figures, wherein:

FIG. 1 shows the configuration of a document management system according to an exemplary embodiment of the invention;

FIG. 2 is a block diagram showing an exemplary configuration of a document generation apparatus;

FIG. 3 is a block diagram showing an exemplary configuration of a document management apparatus;

FIG. 4 schematically shows an exemplary mechanism of a document disposal apparatus;

FIG. 5 is a partially exploded perspective view of the document disposal apparatus;

FIG. 6 is a perspective view of the document disposal apparatus;

FIG. 7 is an exploded perspective view of part of a unit main body;

FIG. 8 is a perspective view of components of the unit main body;

FIG. 9 shows a drive mechanism for a stopper gate;

FIG. 10 is a top view of a scanning unit;

FIG. 11 is a block diagram showing an exemplary configuration of the document disposal apparatus;

FIG. 12 illustrates an exemplary manner of generation of a document;

FIG. 13 shows an exemplary document management table;

FIG. 14 is a flowchart of a processing procedure of the document disposal apparatus;

FIG. 15 illustrates a problem that may occur when a document is inserted in to the document disposal apparatus;

FIG. 16 shows an apparatus structure for solving the problem that may occur when a document is inserted;

FIG. 17 shows an example in which a document tray unit is formed with steps;

FIG. 18 an example in which the document tray unit is provided with a movable guide;

FIG. 19 shows an example in which weights are added to respective weight members; and

FIG. 20 shows an example in which a weight member is formed with a projection.

### DETAILED DESCRIPTION

Exemplary embodiments of the invention will be hereinafter described in detail with reference to the drawings.

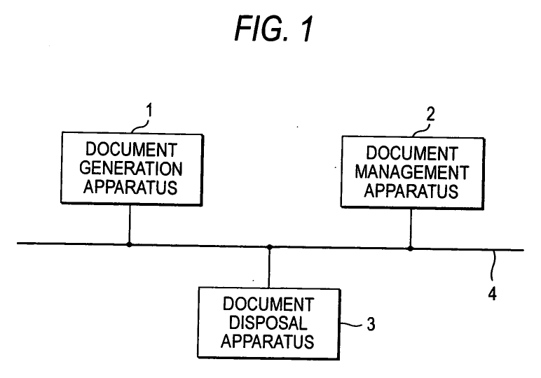

FIG. 1 shows the configuration of a recording-medium management system according to the exemplary embodiment of the invention.

A document generation apparatus 1 generates a recording medium (document) to which a document ID is attached as identification information. A document management apparatus 2 performs various kinds of management processing on documents generated by the document generation apparatus 1. A document disposal apparatus 3 performs disposal processing on documents generated by the document generation apparatus 1 and other documents. A network 4 is configured by using a LAN (local area network) or a WAN (wide area network), for example.

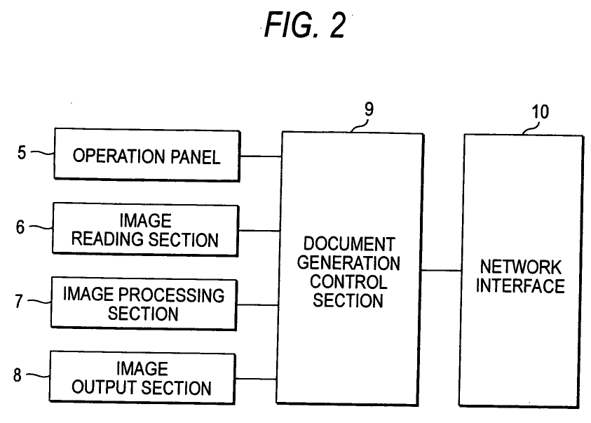

FIG. 2 is a block diagram showing an exemplary configuration of the document generation apparatus 1. The document generation apparatus 1 is configured by using a digital copier, a digital multi-function machine (copier), or the like. The document generation apparatus 1 is composed of an operation panel 5, an image reading section 6, an image processing section 7, an image output section 8, a document generation control section 9, and a network interface 10.

The operation panel 5 serves as a user interface through which a user of the document generation apparatus 1 inputs various kinds of information and on which various kinds of information are displayed for the user. For example, the operation panel 5 is composed of an input unit having various buttons, switches, keys, etc. and a display unit which is a liquid crystal panel with a touch panel.

The image reading section 6 optically reads images of a document, which is a reading target. The image reading section 6 generates image data (scanning data) corresponding to a document sheet image by applying light to the surface of a document sheet set on a transparent document table (platen glass) and forming an image of reflection light returning from the document sheet surface on the photodetecting surface of a reading sensor (CCD sensor or the like) via an image forming optical system including mirrors and lenses. During that course, the document sheet surface is scanned for reading as the image forming optical system is moved.

The image processing section 7 performs prescribed image processing (e.g., color conversion, color correction, gradation correction, enlargement/reduction, image rotation, and screen generation) on the image data produced by reading the document with the image reading section 6.

The image output section 8 prints the image data produced by the reading by the image reading section 6 and subjected to the image processing by the image processing section 7 on recording media such as sheets. The image output section 8 prints the image data by an electrophotographic method, for example.

The document generation control section 9 controls various operations relating to document generation. The document generation control section 9 controls operations of the operation panel 5, the image reading section 6, the image processing section 7, and the image output section 8 according to control programs given in advance.

The network interface 10 is a communication interface via which the document generation apparatus 1 exchanges data with other apparatus (including the document management apparatus 2 and the document disposal apparatus 3) over the network 4. Data exchange via the network interface 10 is controlled by the document generation control section 9.

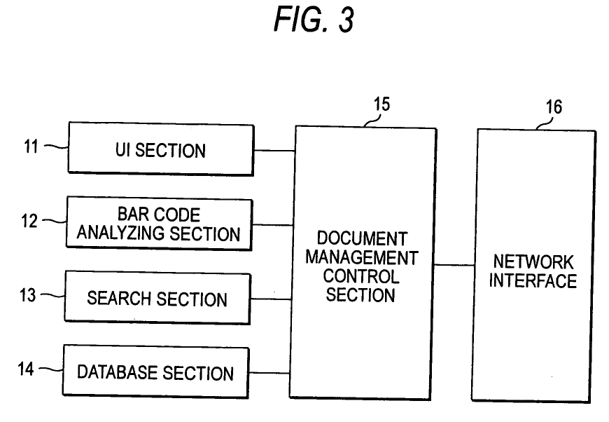

FIG. 3 is a block diagram showing an exemplary configuration of the document management apparatus 2. The document management apparatus 2 is configured by using a personal computer, for example. The document management apparatus 2 is composed of a user interface section (UI section) 11, a bar code analyzing section 12, a search section 13, a database section 14, a document management control section 15, and a network interface 16.

The user interface section 11 is a user interface through which a user of the document management apparatus 2 inputs various kinds of information and on which various kinds of information are displayed for the user. For example, the user interface section 11 is composed of input devices such as a keyboard and a mouse and a display device such as a liquid crystal display.

The bar code analyzing section 12 analyzes and decodes a bar code that is contained in image data (scanning data). A bar code to be analyzed by the bar code analyzing section 12 is one that is contained in image data obtained when images of a document with a bar code are read by the document generation apparatus 1. This bar code is information including at least a document ID. In general, bar codes are generally classified into one-dimensional bar codes in which pieces of information are arranged only in one direction and two-dimensional bar codes in which pieces of information are arranged in two orthogonal directions. Bar codes of both types can be used in practicing the invention. However, where it is desired to have a bar code contain not only a document ID but also other various kinds of information and data, it is desirable to use a two-dimensional bar code having a larger data capacity. This exemplary embodiment employs, as an example, a QR code (registered trademark) which is a kind of two-dimensional bar code and is now widespread.

The search section 13 searches data accumulated in the data base section 14. The data base section 14 accumulates various kinds of data. For example, the database section 14 is configured by using a hard disk drive.

The document management control section 15 controls various operations relating to document management. The document management control section 15 controls operations of the user interface section 11, the bar code analyzing section 12, the search section, and the database section 14 according to control programs given in advance.

The network interface 16 is a communication interface via which the document management apparatus 2 exchanges data with other apparatus (including the document generation apparatus 1 and the document disposal apparatus 3) over the network 4. Data exchange via the network interface 16 is controlled by the document management control section 15.

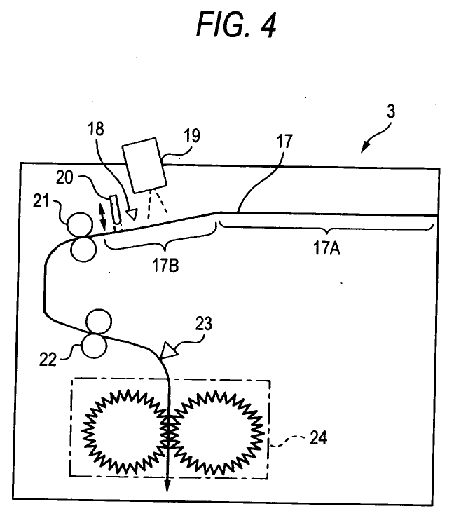

FIG. 4 schematically shows an exemplary mechanism of the document disposal apparatus 3. The document disposal apparatus 3, which is configured by using a shredder, for example, is equipped with a document tray unit 17, an insertion sensor 18, a bar code scanner 19, a stopper gate 20, pairs of feed rolls 21 and 22, a passage sensor 23, and a shredder unit 24.

The document tray unit 17 has a guide surface for supporting a document, which is a disposal target, in such a manner that the document is kept placed there on. The guide surface (top surface) of the document tray unit 17 consists of a horizontal guide surface 17A which is approximately horizontal and a slant guide surface 17B which is inclined from the horizontal guide surface 17A. The slant guide surface 17B of the document tray unit 17 extends from the end of the horizontal guide surface 17A so as to descend gradually toward the feed rolls 21. The slant guide surface 17B of the document tray unit 17 extends past the stopper gate 20 to just in front of the feed rolls 21. A document transport passage is formed downstream of the feed rolls 21 by using a separate chute guide (not shown).

The insertion sensor 18 detects a document that has been inserted to a prescribed position on the document tray unit 17. The prescribed position is such a position that a QR code is located in a code reading area E of the bar code scanner 19, that is, can be read by the bar code scanner 19, when a document on which the QR code is printed as a document ID is inserted in the regular direction. For example, the insertion sensor 18 is a reflection-type optical sensor having a light-emitting element and a photodetector. The insertion sensor 18 is rendered in an on state when a document exists at its sensing position and in an off state when no document exists at the sensing position.

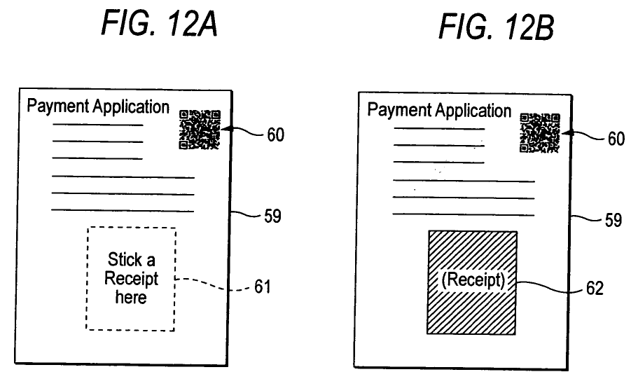

The bar code scanner 19 optically reads a bar code that is attached to a document, which is a disposal target, and outputs original information (data) contained in the bar code of the document. The bar code scanner 19 is configured in such a manner that light emitted from a light source provided inside the scanner 19 is applied to a bar code recording portion of a document, which is a disposal target, and an area sensor captures a bar code image by detecting reflection light via a lens provided inside the scanner 19. The bar code recording portion is a portion of a document surface where a bar code is recorded which includes a document ID and other information. As shown in FIG. 12, the bar code recording portion is located at a corner position of a document and its dimensions are predetermined. Although in this exemplary embodiment the bar code scanner 19 reads a bar code using the area sensor, the configuration of the bar code scanner 19 is not limited to it and may be such as to employ a line sensor in the case where a one-dimensional bar code is to be read.

The stopper gate 20 functions as a restricting unit for stopping a document, which is a disposal target, at the above-mentioned prescribed position in the document insertion direction of the document tray unit 17 until its disposal is permitted. The stopper gate 20 is disposed between the insertion sensor 18 and the feed rolls 21. The stopper gate 20 opens or closes a document transport passage formed by the pairs of feed rolls 21 and 22 at its entrance. In a closed state, the stopper gate 20 is projected downward so as to interrupt a document path from the document tray unit 17 to the feed rolls 21. Therefore, in this state, if a user tries to insert a document inward on the document tray unit 17, the head of the document butts against the stopper gate 20. In contrast, in an open state, the stopper gate 20 is retracted upward from the document path from the document tray unit 17 to the feed rolls 21. Therefore, if a user tries to insert a document inward on the document tray unit 17, the head of the document butts into the nip portion of the feed rolls 21.

The feed rolls 21 rotate while nipping a document that has been introduced by opening the stopper gate 20, and thereby transport the document along a document transport passage, which is formed by a transport guide member (chute or the like; not shown). The feed rolls 22 rotate while nipping a document that has been transported by the feed rolls 21, and thereby transport the document to the shredder unit 24 along the document transport passage.

The passage sensor 23 is disposed at a halfway position (approximately at the center) of the document transport passage from the feed rolls 22 to the shredder unit 24 and detects a passage of a document. For example, the passage sensor 23 is a reflection-type optical sensor having a light-emitting element and a photodetector. The passage sensor 23 is rendered in an on state if a document exists at the sensing position and in an off state if no document exists at the sensing position. Therefore, the passage sensor 23 is switched from an off state to an on state at the same time as the head of a document passes its sensing position. When the tail of the document thereafter passes the sensing position, the passage sensor 23 is switched from the on state to an off state.

The shredder unit 24 shreds (disposes o) a document fed by the feed rolls 22 while pulling the document into itself in one direction (indicated by an arrow). The shredder unit 24 can dispose of plural document sheets (e.g., a bundle of about 20 A4-size plain sheets) together. Furthermore, the shredder unit 24 can dispose of even stapled document sheets as they are (i.e., in a state that staples are not removed).

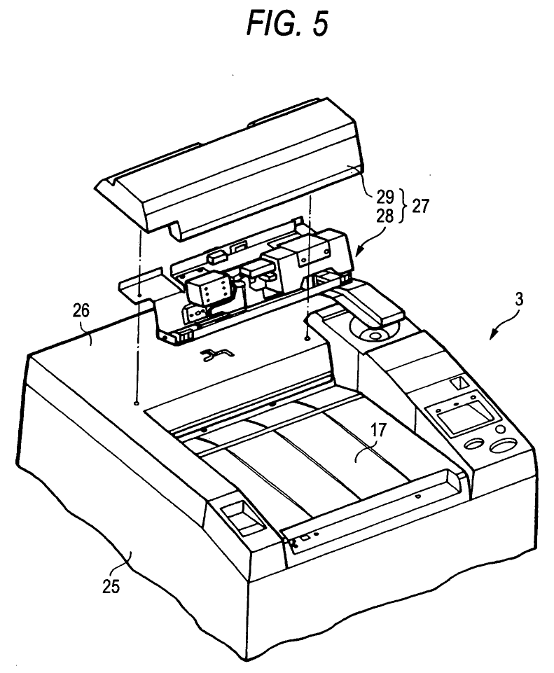

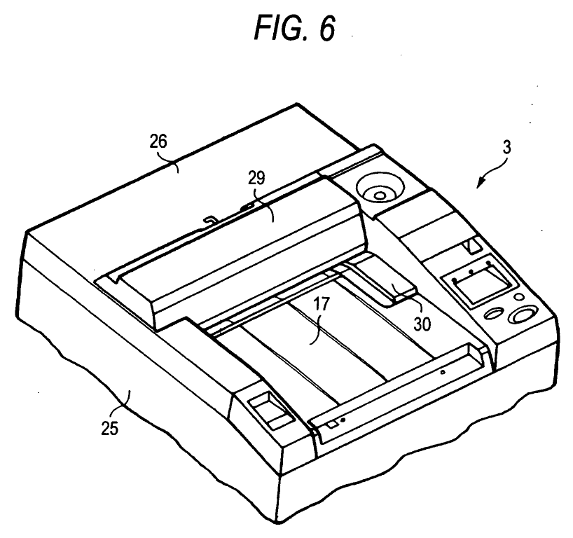

FIG. 5 is a partially exploded perspective view of the document disposal apparatus 3. An apparatus main body 25 of the document disposal apparatus 3 has an upper cover 26 which is integral with the apparatus main body 25. The upper cover 26 is integrally formed with the above-described document tray unit 17. A scanning unit 27 is detachably mounted on the upper cover 26 of the apparatus main body 25 by means of screws, for example. The scanning unit 27 is generally composed of a unit main body 28 and a unit cover 29. The unit cover 29 is a resin cover which covers the unit main body 28 when the scanning unit 27 is mounted on the apparatus main body 25. FIG. 6 shows a state that the scanning unit 27 is actually mounted on the upper cover 26 of the apparatus main body 25.

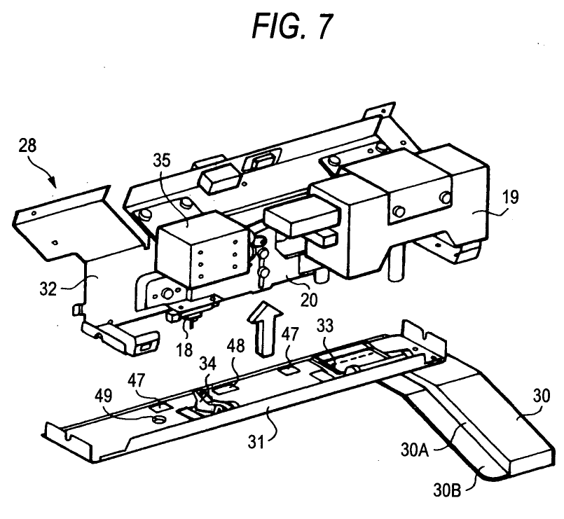

FIG. 7 is an exploded perspective view of part of the unit main body 28. The unit main body 28 has a side guide 30, a first frame member 31, and a second frame member 32. The side guide 30, which is an integral resin mold, for example, is attached to one end portion of the first frame member 31 with screws. When the unit main body 28 is attached to the upper cover 26, the side guide 30 is located at one side end of the document tray unit 17. The side guide 30 is formed with a guide surface 30A which is parallel with the document insertion direction and a chute surface 30B which is perpendicular to the guide surface 30A (the surfaces 30A and 30B form an L-shape).

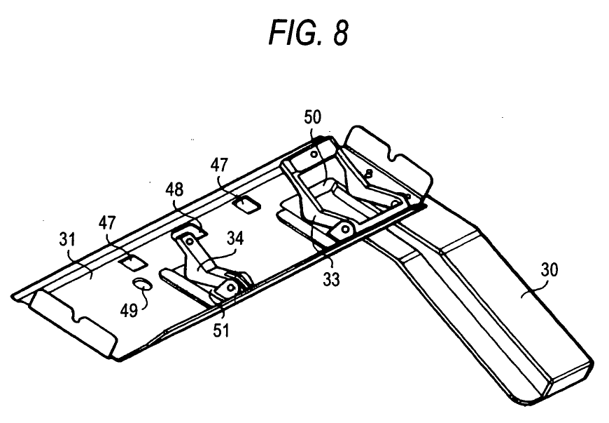

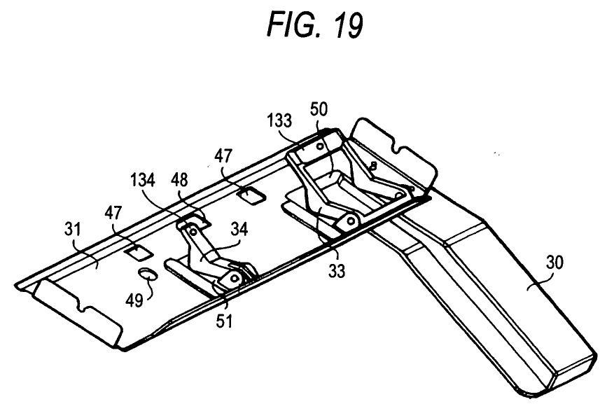

The first frame member 31 serves to form a document insertion guide passage between itself and the document tray unit 17. To this end, the first frame member 31 is attached so that a prescribed gap is formed between itself and the document tray unit 17. As also shown in FIG. 8, a first weight member 33 and a second weight member 34 are attached to the first frame member 31. The weight members 33 and 34 are supported by respective support shafts so as to be swingable about them, the support shafts being provided on the first frame member 31. The weight members 33 and 34 ride, by their own weight, on the top surface of a document that has been inserted manually by a user so as to be located at the prescribed position, and thereby prevent a head-side portion of the document from floating up. Alternatively, as shown in FIG. 19, weight parts 133 and 134 may be added to the respective weight members 33 and 34 to prevent a head-side portion of a document from floating up.

The second frame member 32 is attached to the first frame member 31 with screws. In addition to the above-described insertion sensor 18, bar code scanner 19, and stopper gate 20, a gate solenoid 35 is attached to the second frame member 32. The gate solenoid 35 is a drive source for opening or closing the stopper gate 20.

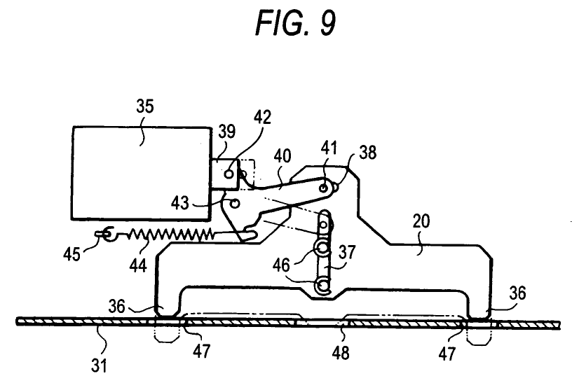

FIG. 9 shows a drive mechanism for the stopper gate 20 which includes the gate solenoid 35. Being a plate-like resin member, for example, the stopper gate 20 has a pair of (i.e., right and left) stopper portions 36 which are integral with the body of the stopper gate 20, as well as a vertically long guide hole 37 and a horizontally long guide hole 38. The pair of stopper portions 36 are formed at the right and left ends of the stopper gate 20 so as to extend downward. The guide hole 37 is formed at the center, in the width direction (right-left direction in FIG. 9), of the stopper gate 20. The guide hole 38 is also formed at the center, in the width direction, of the stopper gate 20 approximately right over the guide hole 37.

The gate solenoid 35 has an output shaft 39, which is linked to the stopper gate 20 via an operation arm 40. That is, the operation arm 40 is linked to the stopper gate 20 via a first engagement pin 41 and linked to the output shaft 39 via a second engagement pin 42. The first engagement pin 41 is engaged with the guide hole 38 of the stopper gate 20.

The operation arm 40 is supported by a support shaft 43 so as to be rotatable about it, the support shaft 43 being provided on the second frame member 32. One end of a helical extension spring 44 is hooked on the operation arm 40, and the other end of the helical extension spring 44 is hooked on a spring hook 45 which is integral with the second frame member 32. The helical extension spring 44 is a member for urging the operation arm 40 in one direction (clockwise in FIG. 9) about the support shaft 43.

The stopper gate 20 is supported by a pair of (i.e., top and bottom) guide pins 46 so as to be movable in the vertical direction, the guide pins 46 being provided on the second frame member 32. The guide pins 46 are spaced from each other in the vertical direction by a prescribed distance and engaged with the guide hole 37 of the stopper gate 20. To prevent the stopper gate 20 from coming off the second frame member 32, coming-off-preventive rings (e.g., C-rings) are attached to the respective guide pins 46.

Gate holes 47 through which the stopper portions 36 of the stopper gate 20 project and retract, a clearance hole 48 for preventing the first frame member 31 from contacting the stopper gate 20, a detection window 49 for the insertion sensor 18, a hole 50 through which the bottom portion of the first weight member 34 is brought into contact with the document tray unit 17, and a hole 51 through which the bottom portion of the second weight member 35 is brought into contact with the document tray unit 17 are formed in the first frame member 31.

In the above-configured drive mechanism for the stopper gate 20, when the gate solenoid 35 is switched from an unexcited state to an excited state, the output shaft 39 is pulled into the solenoid main body against the urging force of the helical extension spring 44, whereby the operation arm 40 is rotated counterclockwise about the support shaft 43. The stopper gate 20 is lifted up by the operation arm 40. As a result, the stopper portions 36 of the stopper gate 20 are retracted through the gate holes 47 of the first frame member 31. In a state that the scanning unit 27 is mounted on the upper cover 26 of the apparatus main body 25, the stopper portions 36 of the stopper gate 20 are spaced from the slant guide surface 17B of the document tray unit 17 (i.e., the stopper gate 20 is opened).

On the other hand, when the solenoid 35 is switched from an excited state to an unexcited state, the operation arm 40 is rotated clockwise about the support shaft 43 by the urging force of the helical extension spring 44, whereby the output shaft 39 of the gate solenoid 35 is pulled out of the solenoid main body. The stopper gate 20 is pushed down by the operation arm 40. As a result, the stopper portions 36 of the stopper gate 20 are projected downward through the gate holes 47 of the first frame member 31. In a state that the scanning unit 27 is mounted on the upper cover 26 of the apparatus main body 25, the stopper portions 36 of the stopper gate 20 are brought in contact with the slant guide surface 17B of the document tray unit 17 (i.e., the stopper gate 20 is closed).

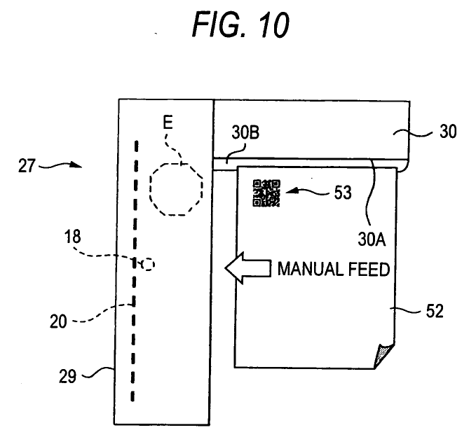

FIG. 10 is a top view of the scanning unit 27. The guide surface 30A of the side guide 30 is parallel with the insertion direction (indicated by a narrow) in which a document 52 is inserted manually. The document 52, which is a disposal target, is inserted with an orientation that a QR code 53 recording portion (printing portion) is located at a head-side corner position. At this time, to position the document 52 in the direction perpendicular to the insertion direction, one sideline of the document 52 is fully brought into contact with the guide surface 30A of the side guide 30. And the portion of the document 52 near the one sideline is placed on the chute surface 30B of the side guide 30.

As a result, in a state that the head of the document 27 is in contact with the stopper gate 20 as a result of manual insertion by a user, the QR code 53 recording portion is positioned inside the code reading area E of the bar code scanner 19. Another possible method for positioning the QR code 53 recording portion inside the code reading area E of the bar code scanner 19 is to use the weight members 33 and 34 in addition to bringing the head of the document 52 into contact with the stopper gate 20 by the user's manual insertion and bringing the one sideline of the document 52 fully in contact with the guide surface 30A of the side guide 30. In this case, even if a head portion of the document 52 is turned up, the positions of the document 52 in the X and y directions do not vary and the first weight member 33 and the second weight member 34 suppress the document 52 from floating up. This makes it possible to read the QR code 53 of the document 52 correctly with the bar code scanner 19.

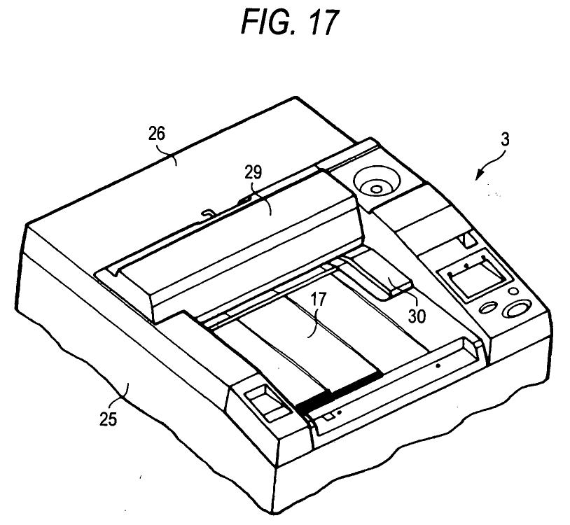

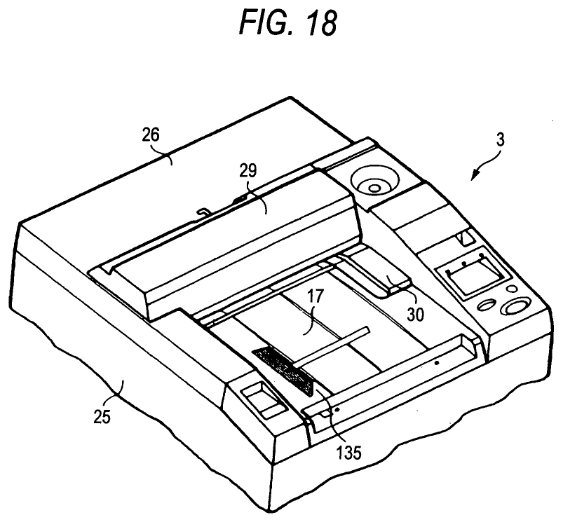

In the above example, a document is positioned by the stopper gate 20, the guide surface 30A of the side guide 30, and the weight members 33 and 34. FIG. 17 shows another example in which the document tray unit 17 is stepped in the direction which the side guide 30 faces toward. The steps are formed in such a manner that their height increases as the corresponding regular sheet size (A4, B4, A3, or the like) increases. As such, each step serves as a guide for preventing a document from being inserted in a wrong direction. Instead of forming steps, a sub-guide 135 capable of being moved in the document width direction in accordance with the document size may be provided as shown in FIG. 18. The above example in which a document is positioned by the stopper gate 20, the guide surface 30A of the side guide 30, and the weight members 33 and 34 is directed to the case of reading a two-dimensional code with the area sensor. On the other hand, in the case of reading a one-dimensional code with a line sensor, a document can be positioned only by the stopper gate 20 or by the stopper gate 20 and the weight members 33 and 34 because it is sufficient to position the document only in the document transport direction and the vertical direction.

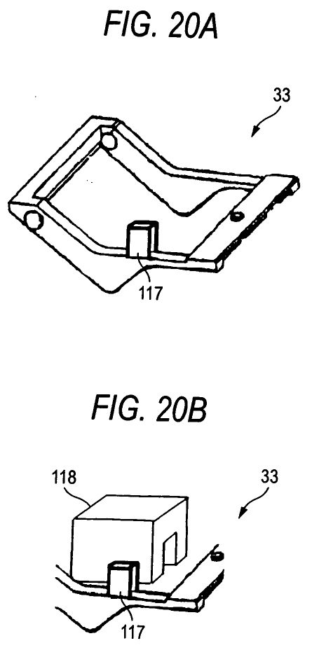

The insertion sensor 18 is disposed immediately upstream of the stopper gate 20 in the document insertion direction. Therefore, the insertion sensor 18 is switched from an off state to an on state immediately before the head of the document 52 butts against the stopper gate 20 as it is inserted manually by a user. Therefore, on-timing of the insertion sensor 18 indicates a time point when the QR code 53 printed on the document 52 is put in the code reading area E and reading should be started. Although in this exemplary embodiment insertion of the document 52 is detected by the insertion sensor 18, insertion of the document 52 may be detected in the following manner. As shown in FIG. 20(A), the weight member 33 or 34 is formed with a projection 117. As shown in FIG. 20(B), a photosensor 118 is turned on or off when the projection 117 intersects the optical axis of the photosensor 118 as the weight member 33 or 34 moves.

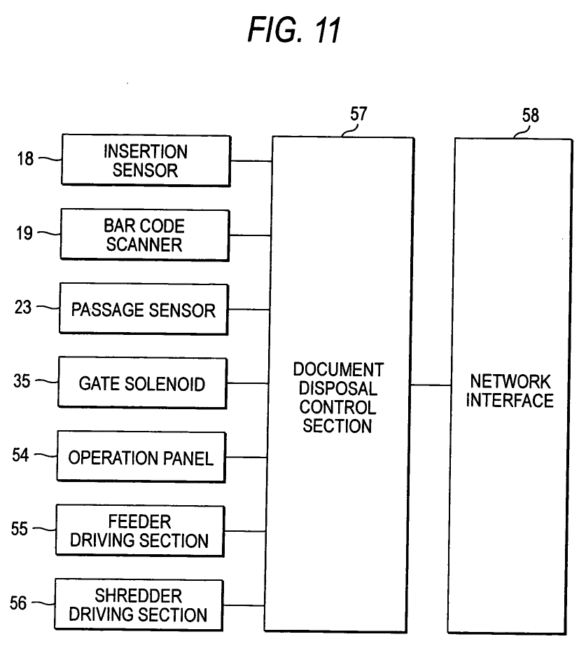

FIG. 11 is a block diagram showing an exemplary configuration of the document disposal apparatus 3. The document disposal apparatus 3 is equipped with, in addition to the above-described components, an operation panel 54, a feeder driving section 55, a shredder driving section 56, a document disposal control section 57, and a network interface 58.

The operation panel 54, which is manipulated by a user of the document disposal apparatus 3, is mounted on the upper cover 26 of the apparatus main body 25. For example, the operation panel 54 is configured by using manipulation buttons (e.g., a start button and a stop button) and a display panel which displays various manipulation pictures including an operation status of the document disposal apparatus 3 and a manipulation guidance (guide message).

The feeder driving section 55 rotates the above-described feed rolls 21 and 22. For example, the feeder driving section 55 may be configured by using a motor as a drive source. The shredder driving section 56 rotates the above-described shredder unit 24. For example, the shredder driving section 56 may be configured by using a motor as a drive source.

The document disposal control section 57 controls various operations relating to document disposal according to control programs given in advance. The document disposal control section 57 is electrically connected to the bar code scanner 19, the operation panel 54, the gate solenoid 35, the feeder driving section 55, and the shredder driving section 56 which are operation control targets. The above-described insertion sensor 18 and passage sensor 23 are electrically connected to the document disposal control section 57.

The network interface 58 is a communication interface via which the document disposal apparatus 3 exchanges data with other apparatus (including the document generation apparatus 1 and the document management apparatus 2) over the network 4. Data exchange via the network interface 58 is controlled by the document disposal control section 57.

Next, a document management method using the above-configured document management system will be described. Documents to which the invention is directed are ones generated by the document generation apparatus 1 while being assigned unique document IDs individually. The document ID may consist of only numerals or may be formed by combining numerals, alphabetical characters, symbols, etc. as appropriate. A specific management method that is directed to a case of handling documents to serve as vouchers for an accounting audit, a tax audit, etc. will be described below.

First, for example, a form of a payment application document 59 as shown in FIG. 12A is generated by inputting document data (electronic data) with a bar code to serve as a document template to the document generation apparatus 1 and printing the document data on a sheet with the image output section 8. For example, the document data may be generated by the document management apparatus 2 and sent from the document management apparatus 2 to the document generation apparatus 1 over the network 4. Alternatively, the document data maybe generated separately by a server apparatus for document data generation and sent from the server apparatus to the document generation apparatus 1 over the network 4.

A QR code 60 which contains a document ID to be assigned to a payment application document 59 and other information is thereby attached, by printing, at a corner position, to the form of a payment application document 59 generated by the document generation apparatus 1. That is, a payment application document 59 to be generated by the document generation apparatus 1 corresponds to a “document to which a document ID is attached.” The form of a payment application document 59 has a region 61 to which a receipt is to be stuck. As shown in FIG. 12B, an applicant generates an original of a payment application document 59 by sticking a receipt 62 to the form of a payment application document 59 and, if necessary, adding statements and putting his or her seal thereto.

After generating the payment application document 59 in the above manner, the applicant sets it on the document table of the document generation apparatus 1 and causes the image reading section 6 to read its image. The image data that have been produced by reading the payment application document 59 with the image reading section 6 are sent to the document management apparatus 2 over the network 4. The original of the payment application document 59 that has been read is filed, for example, and put in storage.

Receiving the image data (scanning data) of the payment application document 59 from the document generation apparatus 1, the document management apparatus 2 stores the image data in the database section 14 and acquires decoded information of the document ID assigned to the payment application document 59 by analyzing the QR code image contained in the received image data with the bar code analyzing section 12. The document management control section 15 registers the thus-acquired document ID in a document management table, which is stored in the database section 14.

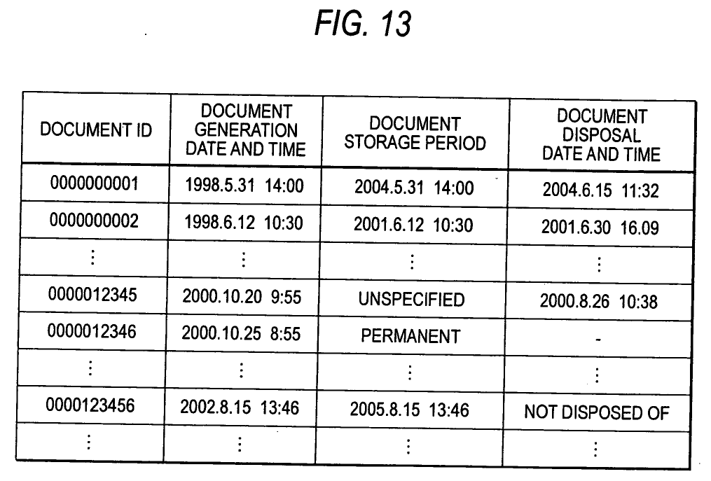

FIG. 13 shows an exemplary document management table. As shown in FIG. 13, a “document ID,” a “document generation date and time,” a “document storage period,” and a “document disposal date and time” are registered in the document management table so as to be correlated with each other. In registering a “document generation date and time” or a “document disposal date and time,” it is desirable that a standard time acquired from a time delivery server or a time authentication server on the Internet via the network 4 be used as a time of the day. The “document ID” may be one obtained by decoding a QR code with the bar code analyzing section 12 or one that was assigned to the document by the document management apparatus 2 itself or a separate server apparatus when it generated document data with a bar code (mentioned above). The “document generation date and time” is a date and time of generation of the document. In this exemplary embodiment, a date and time when image data produced by reading the document such as the payment application document 59 with the document generation apparatus 1 are sent to the document management apparatus 2 or a date and time when the image data sent from the document generation apparatus 1 are received by the document management apparatus 2 is registered as a “document generation date and time.”

The “document storage period” is the end (date and time) of a period in which the document should be kept in storage. Each document whose document ID is registered in the document management table should be kept in storage until the document storage period expires. If the “document storage period” registered is “unspecified,” the document can be disposed of anytime. If the “document storage period” registered is “permanent,” disposal of the document is always prohibited.

For example, if information for setting of a “document storage period” is contained, in addition to the document ID, in the QR code that is printed on the form of a payment application document 59, a “document storage period” can be set automatically on the basis of decoded information that is produced by the bar code analyzing section 12. More specifically, if information to the effect that the document storage period of the payment application document 59 should be set at 6 years is contained in the QR code, a date and time that is 6 years after the date and time of generation of the payment application document 59 can be set automatically as a “document storage period.”

In general, as for receipts, the storage period is determined in accordance with the amount of money received. Therefore, if information indicating the amount of money received of a receipt to be stuck to the form of a payment application document 59 is contained in the QR code, a storage period of the receipt can be determined automatically from that information and registered as a “document storage period” in the document management table. Furthermore, a user can manually change or set a “document storage period” registered or to be registered in the document management table using the user interface section 11 of the document management apparatus 2.

The “document disposal date and time” is a date and time when the document was disposed of. Documents are disposed of by the document disposal apparatus 3. Therefore, a date and time when a notice of completion of disposal of a document (hereinafter also referred to as “disposal completion notice”) is sent from the document disposal apparatus 3 to the document management apparatus 2 with designation of a document ID of a document that has been disposed of is registered in the document management table as a “document disposal date and time.”

A user ID of a user who has generated a document using the document generation apparatus 1 be registered in the document management table as information indicating a document generator, or a user ID of a user who has disposed of a document using the document disposal apparatus 3 be registered in the document management table as information indicating a document disposer. In such a case, ID information of the user who has generated or disposed of the document can be acquired by utilizing an existing user authentication technique (e.g., one using an IC card).

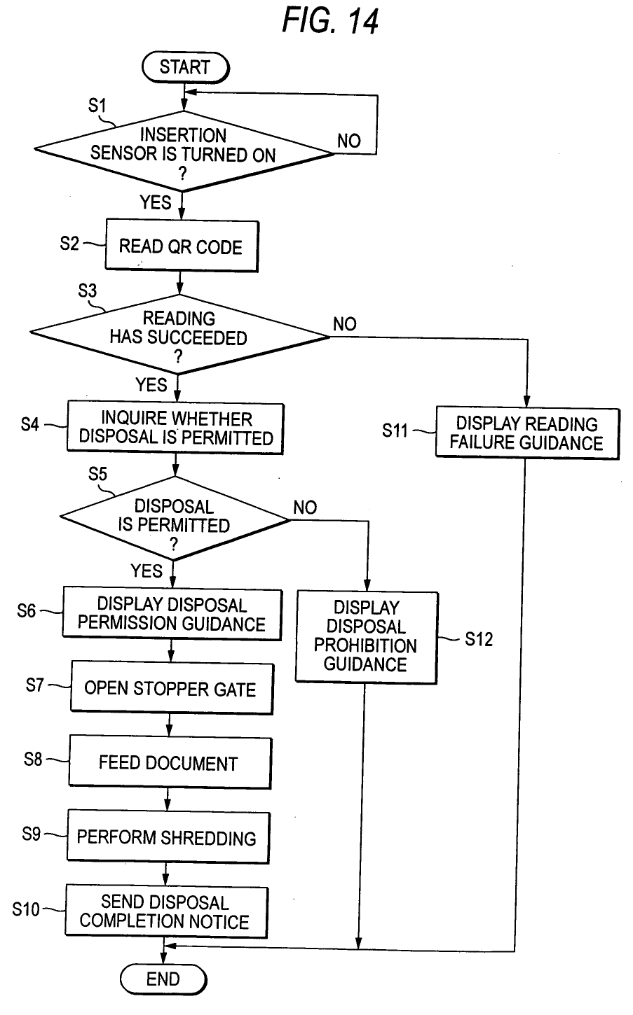

FIG. 14 is a flowchart of a processing procedure which is followed when the document disposal apparatus 3 disposes of a document. The document disposal apparatus 3 has an ordinary disposal mode in which a document is disposed of without reading its document ID (in this exemplary embodiment, a QR code) and a scanning disposal mode in which a document ID of a document, which is a disposal target, is read, whether disposal of the document is permitted is inquired of the document management apparatus 2 with designation of the read-out document ID, and the document is disposed of if disposal permission is obtained from the document management apparatus 2. The flowchart of FIG. 14 shows a processing procedure of the scanning disposal mode.

In the ordinary disposal mode, when the start button on the operation panel 54 is depressed by a user in a state that the document disposal apparatus 3 is in a standby state, the document disposal control section 57 instructs the gate solenoid 35, the feeder driving section 55, and the shredder driving section 56 to start driving, whereby the stopper gate 20 is opened and driving of the feed rolls 21 and 22 and the shredder unit 24 is started. As a result, if the user of the document disposal apparatus 3 places a document, which is a disposal target, on the document tray unit 17 and inserts it inward, the head of the document is nipped by the feed rolls 21 and the document is pulled into the apparatus 3. The document is transported as it is by the feed rolls 21 and 22 and shredded by the shredder unit 24.

If the stop button on the operation panel 54 is depressed by the user after the above-mentioned depression of the start button on the operation panel 54 or if a prescribed time has elapsed from the depression of the start button, the document disposal control section 57 instructs the gate solenoid 35, the feeder driving section 55, and the shredder driving section 56 to stop the driving, whereby the stopper gate 20 is returned to a closed state and the driving of the feed rolls 21 and 22 and the shredder unit 24 is stopped. The document disposal apparatus 3 is thus returned to a standby state.

On the other hand, in the scanning disposal mode, a user of the document disposal apparatus 3 places a document, which is a disposal target, on the document tray unit 17 and inserts it inward. At this time, if a QR code is printed on the document, which is a disposal target, as shown in FIG. 10 the user should insert it with orientation that its QR-code-53-printed surface is made the top surface (i.e., the document is placed with its front side up) and that the QR-code-53-printing portion is located on the downstream side (deep side) in the insertion direction.

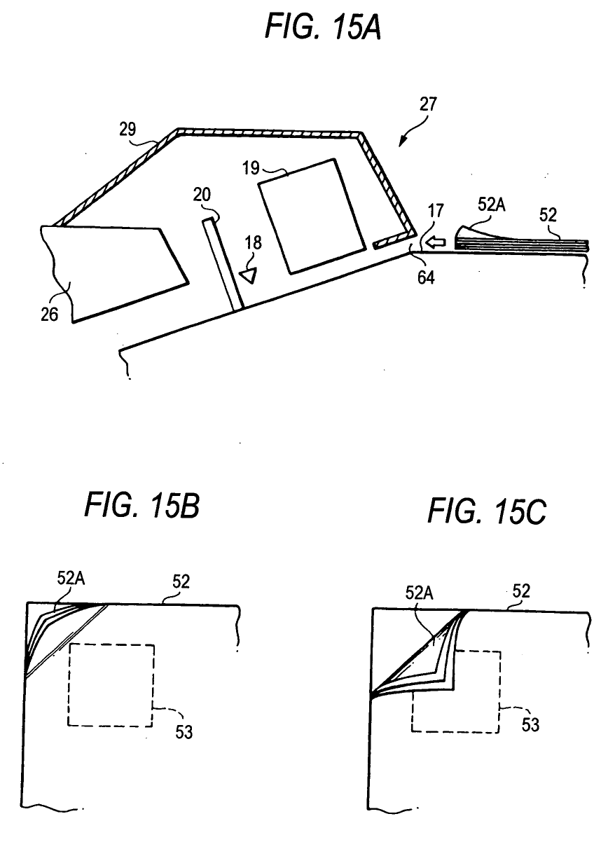

If, for example, a document 52 placed on the document tray unit 17 is an old document that has been read repeatedly or a document that has been circulated among many sections, a situation frequently occurs that as shown in FIG. 15(A) corner portions of the document 52 are turned up. If a corner portion near the QR-code-53-printing portion is turned up as shown in FIG. 15(B), turned-up portions 52A of sheets of the document 52 butt against a document insertion mouth (document intake mouth) 64 through which the document 52 is being inserted manually by the user, as a result of which the document 62 is inserted inward with the turned-up portions 52A folded. As a result, as shown in FIG. 15C, part of the QR code 53 is covered with the folded turned-up portions 52A of the sheets of the document 52. This disables the bar code scanner 19 from reading the QR code 53 of the document 52 correctly.

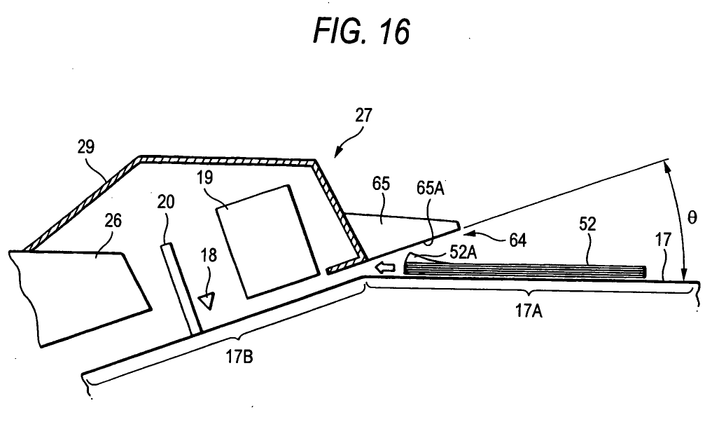

In view of the above, in the document disposal apparatus 3 according to the exemplary embodiment, as shown in FIG. 16, a document intake chute 65 which forms a document insertion mouth 64 is provided integrally with or separately from the unit cover 29 of the scanning unit 27. The document intake chute 65 is a member for correcting head-side turned-up portions 52A, if any, of sheets of a document 52 which is placed on the document tray unit 17.

The document intake chute 65 is provided so as to project from the front end portion of the unit cover 29 toward the side where the horizontal guide surface 17A of the document tray unit 17 exists. The document intake chute 65 has a guide surface 65A which is parallel with the slant guide surface 17B of the document tray unit 17. The guide surface 65A is provided like a visor to define the top boundary of the document insertion mouth 64 and forms a prescribed angle θ with the horizontal guide surface 17A of the document tray unit 17. The prescribed angle θ is set in a range of 15° to 30°, for example. Because of the formation of the angle θ, the vertical interval between the horizontal guide surface 17A of the document tray unit 17 and the guide surface 65A of the document intake chute 65 decreases gradually as the position goes deeper in the document insertion mouth 64.

Since the document intake chute 65 is provided to define the top boundary of the document insertion mouth 64, even if a head portion of a document 52 placed on the document tray unit 17 has turned-up portions 52A, the turned-up portions 52A are pressed down gradually while being kept in contact with the guide surface 65A of the document intake chute 65 as the document 52 is inserted manually into the document insertion mouth 64 by a user. As a result, the turned-up portions 52A of the document 52 are corrected by the document intake chute 65 instead of being folded. This enables the bar code scanner 19 to read the QR code 53 of the document 52 correctly.

When the document is inserted in the above-described manner, the output signal of the insertion sensor 18 is switched from an off state to an on state immediately before the head of the document butts against the stopper gate 20. While the document disposal apparatus is in a standby state, at step S1 the document disposal control section 57 continuously monitors the output signal of the insertion sensor 18 (i.e., its on/off state). If the insertion sensor 18 is turned on as a result of the insertion of the document by the user, the document disposal control section 57 gives a bar code reading instruction to the bar code scanner 19. At step S2, the bar code scanner 19 reads the QR code printed on the document in response to the reading instruction. At this time, since the first weight member 33 and the second weight member 34 suppress a head portion, particularly the QR code recording portion (in the code reading area E) to be read by the bar code scanner 19, of the document from floating up, the QR code printed on the document can face the bar code scanner 19 squarely. This enables the bar code scanner 19 to read the QR code 53 reliably.

At step S3, the document disposal control section 57 judges whether the reading of the QR code has succeeded. Whether the reading of the QR code has succeeded is judged by judging whether the QR code printed on the document has been decoded correctly into a document ID by the bar code scanner 19. There are two major situations that may cause the bar code scanner 19 to fail in reading the QR code. The first situation (absence of a code) is that no QR code is printed on the document or the QR code is located outside the code reading area E (see FIG. 10) because the document is inserted with improper orientation (e.g., the back side of the document rather than its front side is up or the tail of the document rather than its head is inserted first). The second situation (a defective code) is that although the QR code is located in the code reading area E, it is stained or damaged severely or decoded information of the QR code does not contain a document ID.

If the reading of the QR code has succeeded (step S3: yes), at step S4 the document disposal control section 57 inquires of the document management apparatus 2 whether disposal of the document that is identified by the document ID contained in the QR code is permitted. This is done by generating a disposal permission inquiry message in which the document ID contained in the QR code read by the bar code scanner 19 is designated and sending this inquiry message to the document management apparatus 2 via the network interface 58 and the network 4. That is, the document disposal permission inquiry is an inquiry as to whether disposal of the document that is identified by the document ID designated in the inquiry is permitted. If the reading of the QR code has succeeded, the information contained in the QR code may be displayed on the operation panel 54 in a simplified manner.

In the document management apparatus 2 which has received the inquiry message, the search section 13 conducts a search to determine whether the document ID designated in the inquiry message is registered in the document management table. If the document ID concerned exists in the document management table, the document management apparatus 2 checks a “document storage period” that is registered as corresponding to the document ID concerned. If the date and time of reception of the document disposal permission inquiry from the document disposal apparatus 3 (i.e., an inquiry date and time) is after the document storage period, the document management apparatus 2 returns, to the document disposal apparatus 3, a reply message to the effect that disposal of the document is permitted. If the date and time of reception of the document disposal permission inquiry from the document disposal apparatus 3 is not after the document storage period, the document management apparatus 2 returns, to the document disposal apparatus 3, a reply message to the effect that disposal of the document is prohibited.

The document disposal control section 36 receives, via the network interface 58, the reply message returned from the document management apparatus 2. At step S5, the document disposal control section 36 judges whether the reply message returned in response to the inquiry from the document disposal apparatus 3 itself is to permit disposal of the document. If the reply message is to permit disposal of the document, the document disposal control section 57 displays a disposal permission guidance (guide message; prepared in advance) on the operation panel 54 at step S6 and opens the stopper gate 20 by instructing the gate solenoid 35 to do so at step S7. At the same time, the document disposal control section 57 instructs the feeder driving section 55 to start rotating the feed rolls 21 and 22 and, in response, the feeder driving section 55 starts rotating the feed rolls 21 and 22. An exemplary disposal permission guidance is “The document will be disposed of. Please insert the document further inward.”

If the user inserts the document further according to the guidance displayed on the operation panel 54, the head of the document butts into the nip portion of the feed rolls 21 and the document is fed downstream along the document transport passage as the feed rolls 21 rotate (step S8). The document thus fed by the feed rolls 21 is passed to the feed rolls 22 which are located downstream of the feed rolls 21 in the transport direction, and is then transported to the shredder unit 24 as the feed rolls 22 rotate. When the tail of the document passes the sensing position of the insertion sensor 18 and the output signal of the insertion sensor 18 is thereby switched from the on state to an off state, the document disposal control section 57 instructs, with preset timing (e.g., at a time point when the tail of the document passes the feed rolls 21), the gate solenoid 35 to return the stopper gate 20 to the original state (closed state) and the stopper gate 20 is thereby done so.

When the head of the document passes the sensing position of the passage sensor 23 while the document is being transported by the feed rolls 22 and the output signal of the passage sensor 23 is thereby switched from the off state to an on state, the document disposal control section 57 instructs the shredder driving section 56 to start driving and, in response, the shredder driving section 56 starts driving the shredder unit 24. As a result, the document that has been fed by the feed rolls 22 is pulled into the shredder unit 24 as it is and shredded (disposed of) by the shredder unit 24 (step S9).

When the tail of the document passes the sensing position of the passage sensor 23 and the output signal of the passage sensor 23 is thereby switched from the on state to an off state, at step S10 the document disposal control section 57 sends a disposal completion notice (message) which indicates that the disposal of the document concerned has been completed and in which the document ID of the document for which the document disposal permission was received a short while ago is designated, to the document management apparatus 2 after a lapse of a prescribed time (more specifically, a time that is taken until the tail of the document is pulled into the shredder unit 24 and the entire document is shredded) from the time point when the output signal of the passage sensor 23 was switched to the off state. The disposal completion notice (message) is sent to the document management apparatus 2 via the network interface 58 and the network 4. In the document management apparatus 2 which has received the disposal completion notice (message) from the document disposal apparatus 3, a date and time of reception of the message is registered in the column of the “document disposal date and time” as part of disposal history information corresponding to the document ID that is designated in the message.

On the other hand, if it is judged at step S3 that the reading of the QR code has failed, at step S11 a reading failure guidance which was prepared in advance is displayed on the operation panel 54. An exemplary reading failure guidance is “Disposal of this document is prohibited. Please pull out the document.” If disposal of the document is not permitted by the document management apparatus 2 at step S5, at step S12 a disposal prohibition guidance which was prepared in advance is displayed on the operation panel 54. An exemplary disposal prohibition guidance is “This document is cannot be disposed of because its storage period has not expired yet. Please pull out the document.” When sending the disposal completion notice at step S10, the document disposal apparatus 3 immediately returns to a standby state. On the other hand, when the reading failure guidance is displayed at step S11 or the disposal prohibition guidance is displayed at step S12, the document disposal apparatus 3 returns to a standby state after the insertion sensor 18 is switched from the on state to an off state (i.e., the user removes the document from the document tray unit 17).

In the above document management system, document IDs assigned to documents are managed by the document management apparatus 2 so as to be correlated with “document storage periods,” respectively. In disposing of a document using the document disposal apparatus 3, a QR code printed on the document, which is a disposal target, is read by the bar code scanner 19 and the document ID contained in the QR code is acquired. An inquiry as to whether disposal of the document identified by the document ID is permitted is sent to the document management apparatus 2. If a reply to the inquiry means that disposal of the document is permitted, the document disposal apparatus 3 performs disposal processing on the document. Therefore, only documents whose storage periods have expired can be disposed of reliably unlike in the conventional case in which a person in charge is required to check whether disposal of each document is permitted. Furthermore, erroneous discard of a document due to a human check error can be avoided.

Since a document ID assigned to a document generated by using the document generation apparatus 1 is managed by the document management apparatus 2 so as to be correlated with a “document storage period,” the document can be managed all the way from its generation to disposal.

When a document has been disposed of (i.e., shredded) by the document disposal apparatus 3, a disposal completion notice message in which its document ID is designated is sent to the document management apparatus 2 and, upon reception of the message, the document management apparatus 2 registers a document disposal date and time in the document management table as disposal history information corresponding to the document ID. Therefore, the actual date and time of disposal of the document can be kept in storage as history information in association with the fact that the document was disposed of. It is also possible to acquire user ID information or the like of a person (document disposer) who was in charge of the disposal of the document by utilizing a user authentication technique and keep it in storage as another piece of disposal history information. This makes it possible to later check when and by whom a document that is identified by a certain document ID was disposed of.

When a document is generated (printed) by the document generation apparatus 1, a date and time of generation of the document and user ID information or the like of a person (document generator) who is in charge of the generation of the document, together with a document ID of the document, are registered in the document management table of the document management apparatus 2. This makes it possible to later check when and by whom a document that is identified by a certain document ID was generated.

The scanning unit 27 including the insertion sensor 18, the bar code scanner 19, the stopper gate 20, etc. is mounted detachably on the apparatus main body 25 (upper cover 26) of the document disposal apparatus 3. Therefore, with regard to the configuration of the document disposal apparatus 3, it is possible to consider the apparatus main body 25 without the scanning unit 27 a standard configuration and attach the scanning unit 27 as a retrofittable optional component.

Although in the above embodiment a QR code containing a document ID is printed on a document, the invention is not limited to such a case. For example, numerals, symbols, etc. representing a document ID may be printed on a document. Furthermore, the method for attaching a document ID to a document is not limited to printing. For example, a document ID may be attached to a document by sticking a label to the document.

What is claimed is:

1. A recording-medium management system comprising:
a recording-medium management apparatus that manages pieces of identification information attached to recording media; and
a disposal processing apparatus that disposes of a recording medium when receiving disposal permission from the recording-medium management apparatus based on the identification information attached to the recording medium, wherein:
the disposal processing apparatus comprises:
a disposal processing unit that disposes of the recording medium;
a restricting unit that restricts disposal by the disposal processing unit; and
a reading unit that reads identification information from the recording medium, which is positioned by the restricting unit.

2. The system according to claim 1, wherein:
the disposal processing apparatus further comprises a recording-medium pressing unit that prevents the recording medium from floating up, and
the reading unit reads the identification information from the recording medium, which are positioned by the restricting unit and the recording-medium pressing unit.

3. The system according to claim 2, wherein the recording-medium pressing unit is provided to suppress the recording medium from floating up by a weight of the recording-medium pressing unit.

4. The system according to claim 2, wherein the recording-medium pressing unit comprises a weight part having a prescribed weight so as to suppress the recording medium from floating up.

5. The system according to claim 2, wherein a plurality of recording-medium pressing units are arranged in a direction perpendicular to a recording medium insertion direction.

6. The system according to claim 2, wherein:
the disposal processing apparatus further comprises a tray unit on which the recording medium that inserts the recording medium into the reading unit, and
the tray unit decreases in height as going downstream in a recording medium insertion direction.

7. A disposal processing apparatus that disposes of a recording medium when receiving a disposal permission from a recording-medium management apparatus based on identification information attached to the recording medium, the disposal processing apparatus comprising:
a disposal processing unit that disposes of the recording medium;
a restricting unit that restricts disposal by the disposal processing unit; and
a reading unit that reads the identification information from the recording medium that is positioned by the restricting unit.

8. A disposal processing apparatus that disposes of a recording medium based on identification information attached to the recording medium when receiving a disposal permission from a recording-medium management apparatus based on the identification information attached to the recording medium, the disposal processing apparatus comprising:
a disposal processing unit that disposes of the recording medium;
a restricting unit that restricts disposal by the disposal processing unit;
a recording-medium pressing unit that prevents the recording medium from floating up; and
a reading unit that reads identification information from the recording medium that is positioned by the restricting unit and the recording-medium pressing unit.

9. The apparatus according to claim 8,wherein the recording-medium pressing unit is provided to suppress the recording medium from floating up by a weight of the recording-medium pressing unit.

10. The apparatus according to claim 8, wherein the recording-medium pressing unit comprises a weight part having a prescribed weight so as to suppress the recording medium from floating up.

11. The apparatus according to claim 8, wherein a plurality of recording-medium pressing units are arranged in a direction perpendicular to a recording medium insertion direction.

12. The apparatus according to claim 8, further comprising:
a tray unit on which the recording medium that inserts the recording medium into the reading unit, wherein:
the tray unit decreases in height as going downstream in a recording medium insertion direction.

13. The apparatus according to claim 8, further comprising:
a detecting unit that detects a movement of the recording-medium pressing unit, wherein:
the reading unit starts reading the identification information from the recording medium based on a detection result of the detecting unit.

14. The apparatus according to claim 8, further comprising:
a tray unit that inserts the recording medium into the reading unit; and
a side positioning unit that positions one end of the recording medium with respect to the tray unit so that the one end of the recording medium extends along a recording medium insertion direction, wherein:
the reading unit reads the identification information from the recording medium that is positioned by the restricting unit, the recording-medium pressing unit, and the side positioning unit.

15. The apparatus according to claim 14, wherein:
the tray unit comprises a placement surface on which the recording medium, which is a disposal target, is placed,
the placement surface comprises a step in a direction which the side positioning unit faces toward.

16. The apparatus according to claim 15, wherein the step increase in height as a distance from the side positioning unit in the direction which the side positioning unit faces toward, and
the step is provided so as to assist the positioning of the recording medium being inserted.

17. A disposal processing method comprising:
positioning a recording medium;
reading identification information attached to the recording medium from the positioned recording medium;
requesting a disposal permission based on the read identification information of the recording medium; and
disposing of the recording medium if receiving the disposal permission in response to the requesting.
